(19) United States
(12) Patent Application Publication
(10) Pub. No.: US 2016/0288031 A1
(43) Pub. Date: Oct. 6, 2016

(54) Apparatus, System and Method For Connecting Filtration Screens

(71) Applicant: M-I DRILLING FLUIDS U.K. LTD., Aberdeenshire (GB)

(72) Inventor: Claire Rosaleen Galloway McLean, Scotland (US)

(21) Appl. No.: 14/890,607

(22) PCT Filed: Nov. 11, 2015
(86) PCT No.: PCT/US15/60133

§ 371 Date: Nov. 12, 2015

Related U.S. Application Data
(60) Provisional application No. 62/078,801, filed on Nov. 12, 2014.

(51) Int. Cl. B01D 35/30; B01D 29/56; B01D 29/03

(52) U.S. Cl. CPC B01D 35/306; B01D 29/03; B01D 29/56

(57) ABSTRACT

A method, an apparatus and a system connects a high-capacity filtration screen to a regular-capacity filtration screen through an adapter. The adapter is positioned adjacent to the high-capacity filtration screen. Barbs protrude from the high-capacity filtration screen to interlock with the adapter. Barbs extend from the adapter and insert into corresponding orifices in the regular-capacity filtration screen. The filtration screens and adapter are installed in a separator. A tapered edge of the adapter is aligned with the filtration screens. A cross-member extends from a first side to a second side of the adapter. A support beam is positioned lengthwise along an underside of the adapter.

### CROSS-REFERENCE TO RELATED APPLICATION

The present application claims the benefit of, and priority to, U.S. Provisional Patent Application No. 62/078801, filed Nov. 12, 2014, which is hereby incorporated by reference in its entirety.

### BACKGROUND

Separators are used to separate solids from liquids in oil-based and/or water-based drilling fluids, referred to as “muds,” that are retrieved from oilfield drilling operations. For example, such separators may have sifting and/or filtering screens to remove solids from a slurry. One type of apparatus used to separate solids from the muds is referred to in the industry as a “shale shaker.” The shale shaker, also known to as a vibratory separator, uses a sieve to accept used drilling mud to clean the mud for further use in drilling operations.

Mud serves multiple purposes in the industry. Drilling mud acts as a lubricant to cool rotary drill bits and facilitate faster cutting rates. Further, dispersion of the drilling mud around, for example, a drill bit, may assist in counterbalancing various pressures encountered in subterranean formations. Various weighting and lubrication agents are mixed into the drilling mud to obtain the correct mixture for the type and construction of the formation to be drilled.

Because the mud evaluation and/or mixture process may be time consuming and expensive, drillers and service companies typically reclaim and reuse drilling mud. Another purpose of the drilling mud is to carry rocks and/or cuttings from the drill bit to the surface. For example, in a wellbore, the cuttings and/or solids may enter into the drilling mud and may be removed before the drilling mud may be reused.

Typically, shale shakers use sifting and/or filtration screens to separate cuttings from drilling fluid in on-shore and off-shore oilfield drilling operations. The separating screens have a mesh and/or a lattice stretched across a frame. The mesh allows fluid and/or particles smaller than a predetermined size to pass through the separating screen.

To accommodate larger drilling operations and/or drilling operations with a faster through-put of drilling fluid, high-capacity sifting and/or filtering screens have been developed. High-capacity filtering screens are typically made by assembling several separate parts to create a single structure. Further, the additional assembly and/or construction that may be associated with the high-capacity filtration screen may involve additional cost. In contrast, regular-capacity filtering screens typically are fabricated as a single part, and thus are not assembled from multiple separate components. The vibratory separator may demand a regular-capacity screen and/or a high-capacity screen depending on the specific demands of a given drilling operation.

Accordingly, a desire exists for an adapter device that connects and/or attaches a high-capacity filtration screen to a regular-capacity filtration screen to accommodate increased drilling fluid capacity in vibratory separators.

### DESCRIPTION OF THE DRAWINGS

FIG. 1 illustrates a perspective view of an adapter in accordance with embodiments disclosed herein.

FIG. 2 illustrates a top view of a high-capacity screen connected to a regular-capacity filtration screen by an adapter in accordance with embodiments disclosed herein.

FIG. 3 illustrates a perspective view of a high-capacity filtration screen connected to a regular-capacity screen by an adapter in accordance with embodiments disclosed herein.

FIG. 4 illustrates a bottom view of a high-capacity filtration screen connected to a regular-capacity screen by an adapter in accordance with embodiments disclosed herein.

### DETAILED DESCRIPTION

Embodiments disclosed herein are applicable to separation devices that may be utilized in numerous industries. While specific embodiments may be described as utilized in the oilfield services and related industries, such as use with shale shakers, the device may be applicable in other industries where separation of liquid-solid, solid-solid and other mixtures may be separated. The embodiments, for example, may be utilized in the mining, pharmaceutical, food, medical or other industries to separate such mixtures.

In the following detailed description, reference is made to accompanying figures, which form a part hereof. In the figures, similar symbols or identifiers typically identify similar components, unless context dictates otherwise. The illustrative embodiments described herein are not meant to be limiting. Other embodiments may be utilized, and other changes may be made, without departing from the spirit or scope of the subject matter presented here. It will be readily understood that the aspects of the present disclosure, as generally described herein, and illustrated in the figures, may be arranged, substituted, combined and designed in a wide variety of different configurations, which are explicitly contemplated and form part of this disclosure.

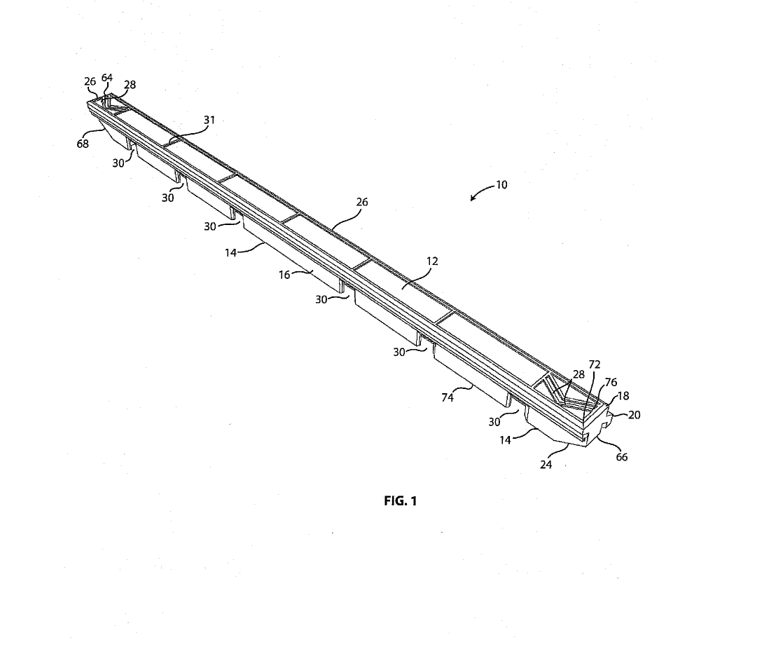

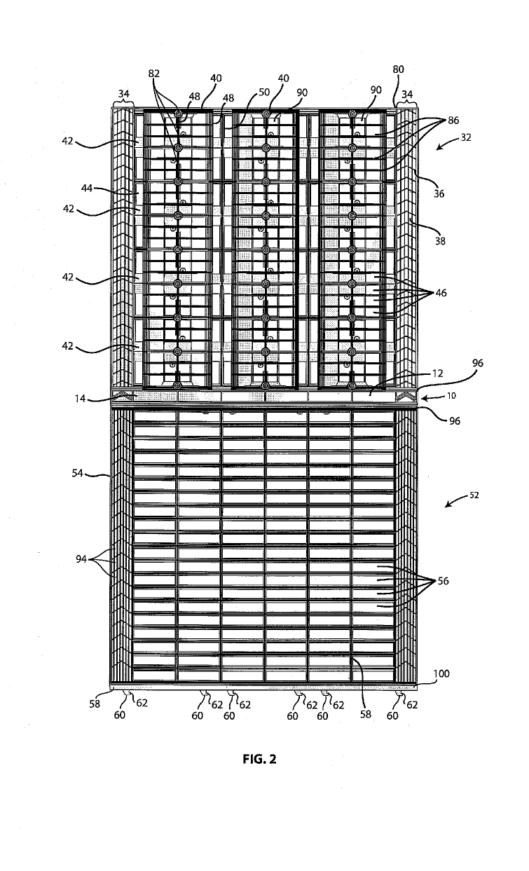

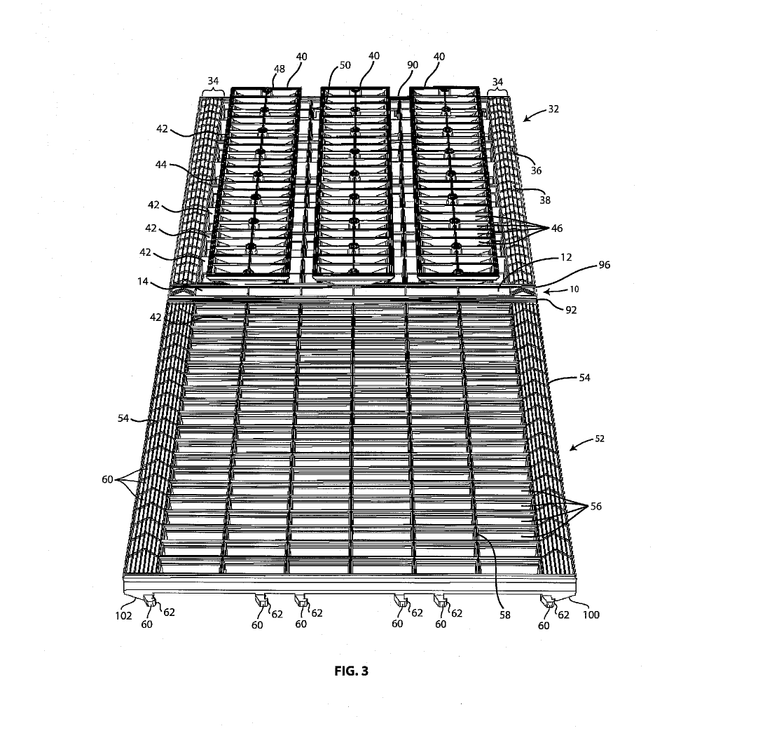

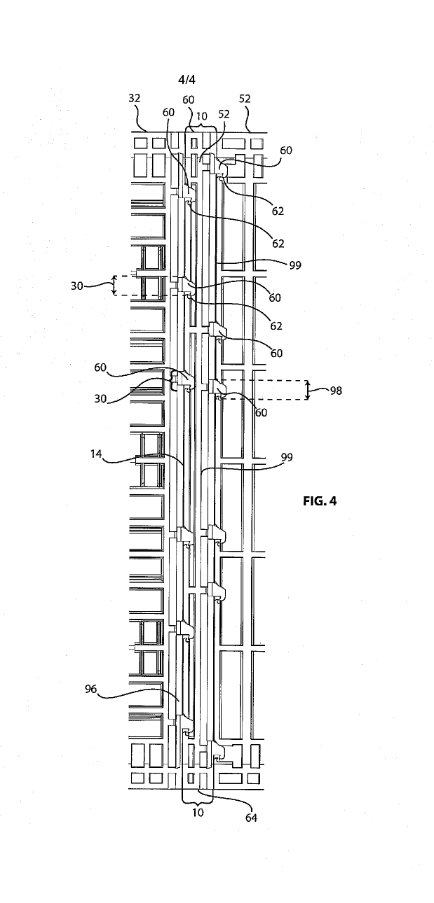

Referring now to FIG. 1, an adapter 10 in accordance with the embodiments disclosed herein is illustrated. The adapter 10 may have a body 16 that may be constructed from a rigid material, such as metal, plastic, composite and/or a combination of the same. The body 16 may have a length equal to and/or equivalent to that of a high-capacity filtration screen 32 and/or a regular-capacity filtration screen 52, as shown in FIGS. 2 and 3. Cut-out regions 30 may have a cross-sectional shape of, for example, a square, and may be positioned and/or distributed across specified intervals across a first side 14 of the adapter 10 as shown in FIG. 1. The cut-out regions 30 may have an internal cavity (not shown) that may hold and/or accommodate hooks and/or barbs 60, as shown in FIG. 4. The barbs 60 may be attached to and may protrude from the high-capacity filtration screen 32 and/or the regular-capacity filtration screen 52. The barbs may provide an interlocking mechanism that may adhere and/or may attach the high-capacity filtration screen 32 and/or the regular-capacity filtration screen 52 to the adapter 10.

Cross-members 31 may be oriented, for example, perpendicular relative to the first side 14 and extend lengthwise across a top surface 12 as shown in FIG. 1 from a lip 26 that may be formed along an upper periphery of the adapter 10. The top surface 12 may have multiple regions and/or sections that may be generally formed and/or defined by the cross-members 31. The high-capacity filtration screen 32 may be interlocked and/or may be connected with the adapter 10 and the regular-capacity filtration screen 52, as shown in FIGS. 2 and 3, to form a single assembly.

The adapter 10 may have a first end 64 that may be positioned opposite to a second end 66. The first end 64 may be identified by, for example, a first tapered portion 68 that may lead toward the lip 26 of the adapter 10. In contrast, the second end 66 may have an end piece 72 with a cross-section as shown in FIG. 1. The second end 66 may have a second tapered portion 24 that generally extends upward from an underside 74 of the adapter 10 to connect with the end piece 72. In an embodiment, the shape, configuration and/or taper of the first tapered portion 68 and/or the second tapered portion 24 may align and/or correspond with a similar angled and/or tapered portion 102 on the regular-capacity filtration screen 32 and/or the high-capacity filtration screen 52.

The first end 64 and the second end 66 may have the cavities 28 that may interconnect with the top surface 12. The cavities 28 may be formed generally to have a shape of a chevron pattern as shown in FIG. 1. The cavities 28 may be defined by the lip 26 at the first end 64 and/or the second end 66. Further, the slurry may, for example, spill into and/or onto the high-capacity filtration screen 32 and/or the regular-capacity filtration screen 52.

In an embodiment as shown in FIG. 1, the second end 66 may have an angled edge 18 that may generally lead from a second side 76 of the adapter 10. A straight edge 20 may be oriented parallel to the first side 14 and the second side 76. The straight edge 20 may extend from the angled edge 18 to connect with the underside 74.

Referring now to FIG. 2, a top view is shown of the adapter 10 that may be attached and/or connected to the high-capacity filtration screen 32 and/or the regular-capacity filtration screen 52. The configuration of the high-capacity filtration screen 32 that may be attached to the regular-capacity filtration screen 52 by the adapter 10 may be used in vibratory separator applications. For example, oilfield drilling operations may use vibratory separators to process and/or cleanse drilling mud for re-use via passage, flow, and/or recycling through the high-capacity filtration screen 32 and/or the regular-capacity filtration screen 52.

The high-capacity filtration screen 32 may be constructed from the connection, attachment and/or assembly of several separate components and/or parts, such as, for example, a side grate 34, a beam 42, a grid 48 and a substructure 50. Each part may be constructed from a rigid material, such as, for example, metal, plastic, composite and/or any combination thereof. The side grate 34 may have angled cross-hatch pieces 36 that may be distributed along the length of the side grate 34. Open regions 38 may be formed throughout the side grate 34 and may be defined by the angled cross-hatch pieces 36. The side grate 34 may be fixed and/or may be attached at an edge 80 of the side grate 34 to the beams 42 and/or the substructure 50 by, for example, screws, bolts and/or fasteners (not shown). The beams 42 and/or the side grate 34, the grid 48 and the substructure 50 may be moved and/or adjusted to accommodate separators of various shapes and sizes.

In an embodiment shown in FIG. 2, the grid 48 may be affixed to and/or on top of the beams 42. The grid 48 may be constructed from connector pieces and/or couplings 82 that may connect and/or may attach panels 86 to the beams 42. The couplings 82 may be circular, as shown in FIGS. 2 and 3, and/or any other suitable shape. Under-beams 90 may attach to, connect and/or provide structural support and/or integrity to the beams 42 and/or the grid 48, the panels 86, the couplings 82 and/or the substructure 50. Liquids from the slurry may pass through openings 46 created by, for example, the configuration of the panels 86 around the beams 42 and/or the substructure 50. Solids and/or solid materials having rocks, rock cuttings, cuttings and/or other forms of debris that may be associated with the slurry may be trapped and/or may accumulate, for example, on a superstructure 40 formed by the assembly of the grid 48, the panels 86 and the couplings 82.

As shown in FIGS. 2-4, a bottom edge 96 of the high-capacity filtration screen 32 may contact the first side 14 of the adapter 10 to insert the barbs 60 into the cut-out regions 30 to connect, attach and/or adhere to the adapter 10. As shown in FIG. 4, the barbs 60 may extend and/or may protrude from the underside 74 of the adapter 10 to interconnect with corresponding ones of the cut-out regions 30 that may be located in the regular-capacity filtration screen 52. In an embodiment, the barbs 60 may have curled tips 62 to assist in attachment of the high-capacity filtration screen 32 and/or the regular-capacity filtration screen 52 to the adapter 10.

The adapter 10 may connect to a frame 92 via the barbs 60 as described above. The frame 92 may generally define the periphery of the regular-capacity filtration screen 52. The frame 92 may have a side grate 54 that may be similar in design, shape and/or function to the side grate 34 of the high-capacity filtration screen 32. The side grate 54 of the regular-capacity filtration screen 52 may have openings 94 that may be similar in shape, form and/or function to the open regions 38 of the high-capacity filtration screen 32. The side grate 54 may be attached at either side of a lattice 58 in, for example, the configuration shown in FIGS. 2 and 3 by screws (not shown). In an embodiment, the regular-capacity filtration screen 52 may have the lattice 58 that may be positioned and/or oriented between the side grates 54. The lattice 58 may be formed and/or constructed from various cross-members 31 that may be positioned as shown in FIGS. 2 and 3, for example.

Similar to the operation and/or function of the high-capacity filtration screen 32, the lattice 58 of the regular-capacity filtration screen 52 may separate solids from liquids in the slurry using the vibratory separator. In the embodiment shown in FIGS. 2 and 3, the regular-capacity filtration screen 52 may be formed substantially as a single part, namely the lattice 58 with the side grates 54 attached thereto.

In contrast, the high-capacity filtration screen 32 may be assembled from several individual parts, such as, for example, the beams 42 and/or the side grate 34, the grid 48, and the substructure 50. The parts may be configured as needed to accommodate a maximum flow rate of the slurry and/or the drilling fluids supplied through the high-capacity filtration screen 32. Accordingly, the high-capacity filtration screen 32, with several independent parts as described above, may have additional manufacturing and/or assembly in comparison to the regular-capacity filtration screen 52, which may, for example, be fabricated as a single part. To accommodate the needs and/or demands of oilfield drilling operations, vibratory separators may use either the high-capacity filtration screen 32 or the regular-capacity filtration screen 52, or may use both the high-capacity filtration screen 32 and the regular-capacity filtration screen 52 in combination. Further, the adapter 10 may connect two high-capacity filtration screens 32 and/or two regular-capacity filtration screens 52.

The drilling fluid and/or the slurry having solids dispersed in and/or suspended in a liquid, such as, rocks, cuttings and/or mud, may be flowed through the high-capacity filtration screen 32 and/or the regular-capacity filtration screen 52 to separate the solids from the liquids. The high-capacity filtration screen 32 and/or the regular-capacity filtration screen 52 may be installed in, for example, a screening deck of the separator. Further, the drilling fluid and/or the slurry may be categorized, for example, as either a “pool” or a “beach.” The “pool” may be defined as an area of the screening deck of the separator that may have drilling fluid with drill cuttings that may be suspended within the drilling fluid. The “beach” may be defined as an area where the drilling fluid and/or the slurry has been mostly removed and/or separated from the cuttings. Accordingly, the “beach” may resemble, for example, a pile of solids.

The high-capacity filtration screen 32 and/or the regular-capacity filtration screen 52 may be oriented, positioned and/or mounted at, for example, an inlet end, an outlet end and/or a discharge end of the vibratory separator. Further, the high-capacity filtration screen 32 may be interchangeable with the regular-capacity filtration screen 52 at, for example, the discharge end of the vibratory separator without affecting the rate at which the vibratory separator may process the drilling fluid.

The ratio of the “pool” to the “beach” of the slurry may be approximately eighty percent “pool” to twenty percent “beach” in traditional oilfield drilling operations. The ratio may be altered to accommodate various needs and/or requirements of cutting dryness and/or flow rates as associated with oilfield drilling operations. In an embodiment, the high-capacity filtration screen 32 and/or the regular-capacity filtration screen 52 may be fixed in, mounted on and/or positioned in the discharge end of the separator. During oilfield drilling operations involving the separator, a conveyance rate of the drilling fluid through the separator may be slowed. Slowing the flow of the drilling fluid through the separator may allow for an extended drying time of solids to produce dried cuttings, i.e. “beach”, and/or to recover the drilling fluid.

Referring now to FIG. 3, a perspective view of the high-capacity filtration screen 32 that may be connected to and/or assembled with the regular-capacity screen 52 via the adapter 10 is shown. As discussed above with respect to FIG. 2, the high-capacity filtration screen 32 may be formed from, constructed with and/or assembled from separate individual components and/or parts. In detail, the side grates 34 may be fixed and/or attached to the beams 42. Gaps 44 may exist in the interstitial areas and/or the spaces between the beams 42 and the side grates 34.

In the embodiment shown in FIGS. 2 and 3, the substructure 50 may be attached to the beams 42. Likewise, the grid 48 may be affixed to the substructure 50. The grid 48 may be assembled, constructed and/or made from panels 86 that may be attached to couplings 82. Under-beams 90 may connect to and/or provide structural support for the beams 42 and/or the grid 48, the panels 86, the couplings 82 and the substructure 50. The openings 46 may be formed by the placement and/or orientation of the panels 86. Liquids from the slurry may pass through the openings 46 and/or the gaps 44; and solids from the slurry may be, for example, trapped and/or lodged in and/or on the grid 48.

The adapter 10 may be positioned lengthwise between the high-capacity filtration screen 32 and the regular-capacity filtration screen 52, as shown in FIGS. 2 and 3. The adapter 10 may connect, adhere and/or attach to the high-capacity filtration screen 32 and the regular-capacity filtration screen 52 via interconnection, attachment and/or penetration of the barbs 60 into and/or through corresponding orifices 98 that may be sized and/or may be located on, for example, the regular-capacity filtration screen 52. For example, in an embodiment shown in FIG. 4, the barbs 60 may protrude from the bottom edge 96 of the high-capacity filtration screen 32 to insert through cut-out regions 30 of the adapter 10 to interface, engage, connect and/or bind the high-capacity filtration screen 52 to the adapter 10. The barbs 60 may protrude from the second side 76 of the adapter 10 to insert through the orifices 98 that may be located on the regular-capacity filtration screen 52.

The regular-capacity filtration screen 52, as shown in FIGS. 2 and 3, may be constructed from the lattice 58 with the side grate 54 mounted on either side of the lattice 58. The openings 56 that may be located on and/or in the high-capacity filtration screen 32 may allow liquids from the slurry to pass; and the solids may be trapped and/or lodged on the lattice 58.

As shown in FIG. 3, the regular-capacity filtration screen 52 may have a bottom edge 100 that may be analogous in size, shape, form and/or function to the bottom edge 96 of the high-capacity filtration screen 32. The bottom edge 100 may have the barbs 60 that may protrude at set distances, as shown in FIG. 3. In an embodiment, the barbs 60 may have curled tips 62 to assist in attachment of the high-capacity filtration screen 32 and/or the regular-capacity filtration screen 52 to the adapter 10.

Referring now to FIG. 4, a bottom view of an embodiment of the adapter 10 as used in interfacing and/or attaching the high-capacity filtration screen 32 to the regular-capacity filtration screen 52 is shown. The adapter 10 may be positioned between the high-capacity filtration screen 32 and the regular-capacity filtration screen 52. In an embodiment, the barbs 60 may protrude from the high-capacity filtration screen 32 to insert through cut-out regions 30 of the adapter 10 to attach, engage, connect and/or bind the high-capacity filtration screen 32 to the adapter 10. As shown, the bottom edge 96 of the high-capacity filtration screen 32 may contact, touch and/or compress against the first side 14 of the adapter 10 when the barbs 60 are inserted into the adapter 10. The barbs 60 may have curled tips 62 to grasp, adhere and/or attach to the adapter 10, the high-capacity filtration screen 32 and/or the regular-capacity filtration screen 52. In particular, the barbs 60 may protrude from the second side 76 of the adapter 10 to insert through the orifices 98 that may be located on the regular-capacity filtration screen 52. The adapter 10 may also have a rib 99 that may extend across the length of the adapter 10. The rib 99 may provide rigidity and/or strength to the adapter 10.

A method, an apparatus and a system may connect the high-capacity filtration screen 32 to the regular-capacity filtration screen 52 through the adapter 10. The adapter 10 may be positioned adjacent to the high-capacity filtration screen 32. The barbs 60 may protrude from the high-capacity filtration screen 32 to interlock with the adapter 10. Barbs 60 may extend from the adapter 10 and may insert into corresponding orifices 98 in a regular-capacity filtration screen 52. The combined filtration screens 32, 52 and the adapter 10 may be installed in the separator (not shown). The tapered edges 24, 68 of the adapter 10 may align with the filtration screens 32, 52. The cross-members 31 may extend from the first side 14 to the second side 76 of the adapter 10. The rib 99 may be positioned lengthwise along the underside 74 of the adapter 10.

Although the preceding description has been described herein with reference to particular means, materials, and embodiments, it is not intended to be limited to the particulars disclosed herein; rather, it extends to all functionally equivalent structures, methods, and uses, such as are within the scope of the appended claims.

1. A method comprising:
positioning an adapter adjacent to a first filtration screen;
interlocking a first barb extending from the first filtration screen with an orifice in the adapter;
inserting a second barb extending from the adapter into a second filtration screen to form a filtration screen assembly; and
installing the filtration screen assembly in a separator.

2. The method of claim 1 further comprising:
reinforcing the first filtration screen by a substructure attached to the first filtration screen.

3. The method of claim 1 further comprising:
attaching a panel to the first filtration screen wherein the panel directs a flow of fluid through the first filtration screen.

4. The method of claim 1 further comprising:
connecting a side grate to the filtration screen assembly wherein the side grate collects solids.

5. The method of claim 1 further comprising:
flowing liquids through a grid in the filtration screen assembly.

6. The method of claim 1 further comprising:
collecting solids on the filtration screen assembly.

7. The method of claim 1 further comprising:
flowing a first volume of fluid through the first filtration screen and a second volume of fluid through the second filtration screen wherein the first volume is different than the second volume.

8. An apparatus comprising:
a first screen having a grid and a substructure wherein the substructure is attached to the grid and further wherein the first screen has a tab extending from the first screen;
an adapter with a top surface, a first side and a second side wherein the first side of the adapter has a cut out to receive the tab and further wherein the second side has a barb extending from the second side; and
a second screen formed from a lattice wherein the second screen has an opening configured to accept the barb.

9. The apparatus of claim 8 wherein the barb has a curved tip.

10. The apparatus of claim 8 further comprising:
a tapered edge on the adapter wherein the tapered edge is aligned with the first screen and the second screen.

11. The apparatus of claim 8 further comprising:
a lip extending from the top surface along the first side and the second side.

12. The apparatus of claim 8 further comprising:
a truss extending from the first side to the second side across the top surface.

13. The apparatus of claim 8 further comprising:
a rib positioned along the adapter between the first side and the second side wherein the rib reinforces the adapter.

14. The apparatus of claim 8 further comprising:
a side grate attached to the grid wherein the side grate processes a flow of fluid over the first screen.

15. A system comprising:
a first filtration screen assembled from a grid on a substructure wherein the grid has openings that permit fluid from a slurry to pass wherein the grid traps solids from the slurry wherein the first filtration screen has a barb that protrudes from the first filtration screen wherein the first filtration screen has a width;
a connecter having a first side and a second side located in a position opposite to the first side wherein the connector has a width substantially equivalent to the width of the first filtration screen wherein the first side of the connector has a cut out region that receives the barb to link the first filtration screen to the connector and further wherein a hook extends from the second side of the connector; and
a second filtration screen formed from a lattice wherein the second filtration screen has a hole to accept the hook of the connector to attach the connector to the second filtration screen.

16. The system of claim 15 further comprising:
a support beam positioned along the width of the connector.

17. The system of claim 15 further comprising:
a panel coupled to the grid wherein the panel directs flow of the slurry on the grid.

18. The system of claim 15 further comprising:
a plurality of barbs located on the second side along the width of the connector.

19. The system of claim 15 further comprising:
a plurality of notches located on the first side along the width of the connector.

20. The system of claim 15 wherein the first filtration screen has a first capacity and the second filtration screen has a second capacity wherein the first capacity is different than the second capacity.
